(19) United States
(12) Patent Application Publication
(10) Pub. No.: US 2014/0327847 A1
(43) Pub. Date: Nov. 6, 2014

(54) TOUCH PANEL

(71) Applicant: LG INNOTEK CO., LTD., Seoul (KR)

(72) Inventors: Bong Jun Park, Seoul (KR); Sun Hong Yoon, Seoul (KR); Yong Jin Lee, Seoul (KR); Kwang Yong Jin, Seoul (KR); Kyoung Hoon Chai, Seoul (KR)

(21) Appl. No.: 14/361,748

(22) PCT Filed: Nov. 12, 2012
(86) PCT No.: PCT/KR2012/009505

§ 371 Date: May 30, 2014

(30) Foreign Application Priority Data
Nov. 30, 2011 (KR) 10-2011-0127351

(51) Int. Cl. G06F 3/041

(52) U.S. Cl. CPC G06F 3/0414
USPC 349/12

(57) ABSTRACT

Disclosed is a touch panel. The touch panel includes a first substrate; a second substrate spaced apart from the first substrate; an electrode on at least one of the first substrate and the second substrate for detecting a position; and a piezoelectric part having an elasticity which varies depending on an electric field induced by the electrode, wherein the piezoelectric part includes a base and particles distributed into the base, and the base includes a polymer material having elasticity.

### TECHNICAL FIELD

The disclosure relates to a touch panel.

### BACKGROUND ART

A touch panel is one of user's input apparatuses which determine an input and an input position by sensing a user's touch. A user may input data or a signal by touching or pressing the touch panel with fingers or a stylus pen. The touch panel may be used as a touch pad in substitution for a mouse in a laptop computer or a netbook, or in substitution for an input switch of an electronic appliance.

The touch panel may be integrally combined with a display. The touch panel, which is installed on an image display surface of a display such as a liquid crystal display (LCD), a plasma display panel (PDP) or a cathode ray tube (CRT), is called ‘touch screen’. The touch screen may be integrally formed with a display to form an image display surface of the display, or may be attached onto the image display surface of the display.

The touch panel may substitute for a mechanical user's input apparatus such as a keyboard and may be manipulated simply.

The touch panel may provide various types of input buttons to a user according to a type or a stage of an executed application. Thus, the touch panel has been widely used as an input device of an electronic appliance such as an automated teller machine (ATM), an information searching apparatus, a ticket vending machine, a mobile phone, a personal digital assistant (PDA), a portable multimedia player (PMP), a digital camera, a portable game machine, and an MP3 player.

The touch panel may be classified into a resistive type touch panel, a capacitive type touch panel, a saw type touch panel and an infrared type touch panel according to the method for sensing the input from the user. For example, the capacitive type touch panel determines whether an input occurs at a specific position by sensing a variation of electrostatic capacity at the specific position according to a touch or pressing. However, a touch panel according to the related art does not provide a user with an input sense such as input feeling or haptic feeling. For solving this problem, a method of installing a vibration motor at a lower portion of the touch panel has been proposed. According to the above method, when an input is sensed, the touch panel is entirely vibrated by the vibration motor, so that the input or haptic feeling is provided to a user.

Specifically, in a touch panel employing a viscosity variation of a fluid for providing the input feeling or haptic feeling, the fluid may leak out between the touch panel and a substrate, so that the reliability of the touch panel may be reduced. In addition, it is difficult to fill the touch panel with an exact amount of fluid.

### DISCLOSURE OF INVENTION

### Technical Problem

The embodiment provides a touch panel capable of providing various input or click feelings to a user through a touch sense.

### Solution to Problem

According to one embodiment, there is provided a touch panel. The touch panel includes a first substrate; a second substrate spaced apart from the first substrate; an electrode on at least one of the first substrate and the second substrate for detecting a position; and a piezoelectric part having an elasticity which varies depending on an electric field induced by the electrode, wherein the piezoelectric part includes a base and particles distributed into the base, and the base includes a polymer material having elasticity.

### Advantageous Effects of Invention

The touch panel according to the embodiment includes the piezoelectric part including the base and the particles. Since the base includes the polymer material having elasticity, the embodiment may have an advantage in the process. That is, since the base is formed of a fluid, the phenomenon that the fluid flows between the electrodes can be prevented. According to the embodiment, since an exact amount of the base is provided, reliability can be improved.

The base is placed between the electrodes to serve as an insulator. The base supports the particles such that the particles can be distributed in precise positions. In addition, when a load is applied to the touch panel, the elasticity of the base varies so that piezo-electric effect may be given.

An attractive force between the particles may vary according to an electric field. The elasticity of the base may vary by varying the attractive force.

A refractive index of the base corresponds to that of the particles. That is, the refractive index of the base may be equal to that of the particles. Thus, the transparent piezoelectric part may be provided.

### BRIEF DESCRIPTION OF DRAWINGS

FIG. 1 is an exploded perspective view showing a touch panel according to the embodiment; and

FIG. 2 is a sectional view taken along line A-A′ of FIG. 1.

### MODE FOR THE INVENTION

In the description of the embodiments, it will be understood that when a layer, a film, a region, a pattern or a structure is referred to as being “on” or “under” another substrate, another layer, another film, or another pattern, it can be “directly” or “indirectly” on the other layer, the other film, the other pattern, or one or more intervening layers may also be present. The positions of each layer have been described with reference to the drawings.

The size or thickness of the elements shown in the drawings may be exaggerated for the purpose of obvious and convenient explanation and may not utterly reflect the actual size.

Hereinafter, embodiments will be described in detail with reference to the accompanying drawings.

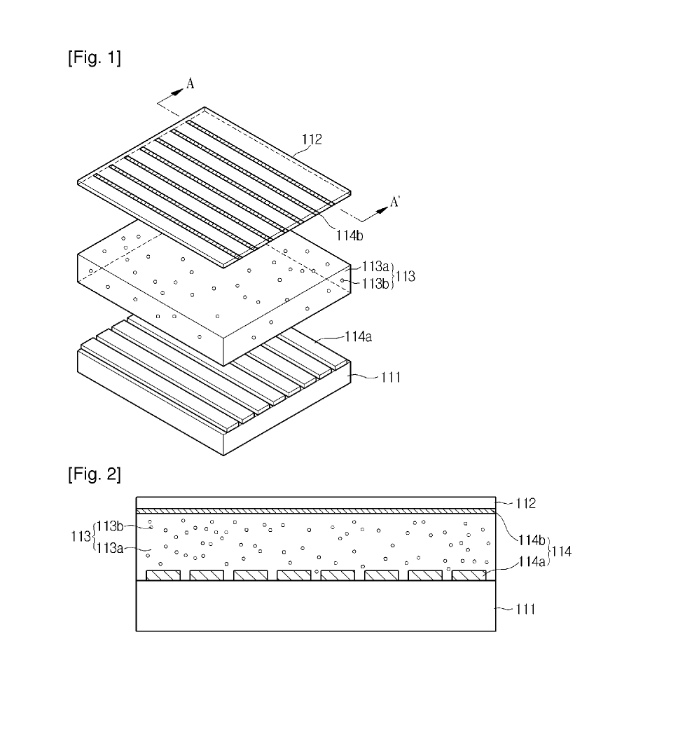

A touch panel according to the embodiment will be described with reference to FIGS. 1 and 2. FIG. 1 is an exploded perspective view showing the touch panel according to the embodiment. FIG. 2 is a sectional view taken along line A-A′ of FIG. 1.

Referring to FIG. 1, the touch panel according to the embodiment includes a first substrate 111, a second substrate 112, an electrode 114 and a piezoelectric part 113.

The first substrate 111 may be placed at a lower portion of the touch panel. The first substrate 111 may be a base substrate of the touch panel.

When the touch panel is operated as a touch screen of an electronic appliance, the first substrate 111 may become a display surface of the electronic appliance or may become a substrate which is additionally attached onto the display surface of the electronic appliance.

The first substrate 111 may not be modified although a predetermined attractive or repulsive force is applied between the first and second substrates 111 and 112. To do this, the first substrate 111 may be formed of a rigid material. For example, the first substrate 111 may be a glass substrate formed of transparent glass. However, the first substrate 111 must not be formed of a rigid material. For instance, if the touch panel is attached onto an upper portion of a rigid display, the first substrate 111 may be formed of a transparent polymer film.

The second substrate 112 may be spaced apart from the first substrate 111.

A top surface of the second substrate 112 is a user touch surface touched by a user in input. The second substrate 112 may be modified when a predetermined force is applied to the second substrate 112. For example, when a user touches or presses the user touch surface with his finger or a stylus pen, the second substrate 112 may be modified. To this ends, the second substrate 112 may be formed of a polymer film which is transparent and is capable of being modified. The polymer is not limited to any specific kind.

The second substrate 112 is disposed to be spaced apart from the first substrate 111 by a predetermined interval, so that a predetermined size of a gap is formed between the first and second substrates 111 and 112. The size of the gap may vary according to a level of a driving voltage, an area of a touch panel body and a sectional area of the electrode 114.

The electrode 114 is provided on the first and second substrates 111 and 112. The electrode 114 is a pair of electrodes 114.

The electrode 114 may include the first electrode 114a and the second electrode 114b. In detail, the first electrode 114a may be provided on the first substrate 111. The first electrode 114a may include a plurality of electrodes which are formed in the first direction.

The second electrode 114b may be provided on the second substrate 112. The second electrode 114b may include a plurality of electrodes which are formed in the second direction crossing the first direction.

These electrodes 114 may be arranged on the entire surface or a partial surface in a matrix type. The driving voltage may be applied to a predetermined combination of the electrodes 114 which are arranged in the matrix type.

The number of electrodes 114 may provide various strengths of input or click feelings, that will be described below, by varying the number of the electrodes 114, a displacement size of the second substrate 112 at a time point when the applied driving voltage is released, and the number of the electrodes 114 from which the applied driving voltage is released.

Meanwhile, referring to FIG. 1, the electrodes 114 may be formed in a line type.

However, the embodiment is not limited to the above, differently from as depicted in FIG. 1, the electrodes 114 may be disposed on the first and second substrates 111 and 112 in a dot type. The first and second electrodes 114a and 114b crossing each other may be disposed on the entire surfaces or the partial surfaces of the first and second surfaces 111 and 112. The electrodes 114 may have a pattern of a polygonal shape such as a rectangular shape or a circular shape. The electrodes 114 of the dot type may be individually connected to switchable active devices, such that the electrodes 114 of the dot type may be individually switched by the switchable active devices in response to a control signal from a controller.

The driving voltage applied to the electrodes 114 provides a driving force for partially varying elasticity of the piezoelectric part 113. The driving voltage may be supplied from a power supply of an electronic appliance on which the touch panel is mounted. The number of the electrodes 114 to which the driving voltage is applied, the displacement area of the second substrate 112 at the time point when the driving voltage is released, and the number of the electrodes 114 from which the driving voltage released may be controlled by the controller (not shown).

When the driving voltage is applied to an electrode 114, an electric field is partially induced at the gap between the first and second substrates 111 and 112 corresponding to the position of the corresponding electrode 114. In detail, when the driving voltage having a predetermined potential is connected to one driving electrode 114, and the other driving electrode 114 is grounded, an electric field is partially induced.

Meanwhile, the piezoelectric part 113 may be placed at the gap between the first and second substrates 111 and 112. That is, the piezoelectric part 113 may be placed between the first and second substrates 111 and 112.

The piezoelectric part 113 includes a base 113a and particles 113b.

The base 113a may include a polymer material having elasticity. The polymer material includes a crosslink. In detail, polymer chains included in the polymer material are physically or chemically cross-linked. The crosslink may include a hydrogen bond, a pi bond, a covalent bond, and an ionic bond.

The polymer material has a dielectric constant of 3 F/m or more.

The polymer material may include amorphous rubber. That is, the polymer material has an amorphous property. Since the polymer material has the amorphous property, the transparent piezoelectric part 113 may be provided.

The polymer material may include polysiloxane. For example, the polymer material.

may be polydimethylsiloxane (PDMS).

The polymer material may include a functional group. Specifically, the polymer material may include PDMS including the functional group.

As one example, the polymer material may be polydiphenylsiloxane obtained by substituting phenyl groups for all methyl groups of PDMS. The polydiphenylsiloxane is expressed as Chemical formula 1:

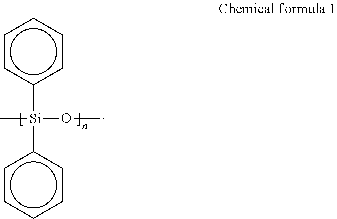

Further, the polymer material may be polymethylphenylsiloxane expressed as Chemical formula 2:

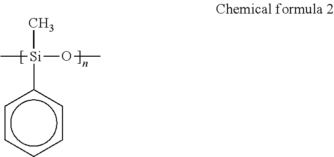

However, the embodiment is not limited to the above, and the polymer material may include a material obtained by substituting an alkyl group, a glycol group or a phenyl group for the methyl group of the polydimethylsiloxane.

However, the embodiment is not limited thereto. For example, the polymer material may include various kinds of rubbers, which have transparent and insulating properties with a dielectric constant of 3 F/m or more. Thus, the polymer material may include polyvinyl chloride, urethane, epoxy, silicon, or isoprene.

The base 113a may be placed between the electrodes 114 to serve as an insulator.

Further, the base 113a may support the particles 113b such that the particles 113b may be distributed in precise positions. Further, when a load is applied to the touch panel, the elasticity of the base 113a may vary such that piezoelectric effect may be given.

Further, since the base 113a includes the polymer material having the elasticity, the embodiment may have an advantage in the process. That is, when the base 113a is formed of a fluid, the phenomenon that the fluid flows between the electrodes 114 may be prevented. According to the embodiment, since an exact amount of the base 113a is provided, reliability may be improved.

The particles 113b may include a conductive material. That is, the particles 113b may include a material having a high dielectric constant and a large quantity of electric charge. In detail, the particles 113b may include silica. The particles 113b may include the silica of which the surface is treated with phosphoric acid. The particles may include a material which is produced by coating carbon nano-tubes or conductive polymer on polymethylmethacrylate (PMMA), polystyrene (PS), or silica.

The attractive force between the particles 113b may vary according to the electric field. In detail, the attractive force between the particles 113b may vary according to the electric field induced by the driving voltage applied to the touch panel. The elasticity of the base 113a may vary by varying the attractive force. That is, when a load is applied to the touch panel, the elasticity of the base 113a varies, so that piezo-electric effect may be given.

The particles 113b may have a diameter in a range of 50 nm to 10 μm. When the diameter of the particles 113b is less than 50 nm, the variation of the attractive force between the particles 113b may be insufficient. When the diameter of the particles 113b exceeds 10 μm, the particles 113b may be viewed to the human eye and the weight of the particles 113b may be too heavy so that the particles 113b may not be distributed well.

The volumetric ratio the particles to the base 113a may be in a range of 5% to 30%. When the volumetric ratio of the particles 113b to the base is less than 5%, the attractive force between the particles 113b may be insufficient. When the volumetric ratio of the particles 113b to the base is more than 30%, the particles 113b may not be distributed well.

The refractive index of the base 113a corresponds to the refractive index of the particles 113b. That is, the refractive index of the base 113a may be equal to the refractive index of the particles 113b. Thus, the piezoelectric part 113 may be transparent.

The piezoelectric part 113 may have a thickness in the range of 100 μm to 4 mm. When the thickness of the piezoelectric part 113 is less than 100 μm, the insulation effect of the piezoelectric part 113 may be deteriorated and the voltage structure may be broken. Thus, a noise may be generated and the reliability of the touch panel may be deteriorated. When the thickness of the piezoelectric part 113 is more than 4 mm, a stress of the touch panel may be increased, and it may be difficult to process the touch panel.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A touch panel comprising:
a first substrate;
a second substrate spaced apart from the first substrate;
an electrode on at least one of the first substrate and the second substrate for detecting a position; and
a piezoelectric part having an elasticity which varies depending on an electric field induced by the electrode,
wherein the piezoelectric part includes a base and particles distributed into the base, and the base includes a polymer material having elasticity.

2. The touch panel of claim 1, wherein the polymer material includes a crosslink.

3. The touch panel of claim 2, wherein the polymer material has a di-electric constant of 3 F/m or more.

4. The touch panel of claim 2, wherein the polymer material has an amorphous property.

5. The touch panel of claim 1, wherein the polymer material includes polysiloxane.

6. The touch panel of claim 1, wherein the polymer material includes polydimethylsiloxanes (PDMS).

7. The touch panel of claim 1, wherein the polymer material includes a functional group.

8. The touch panel of claim 1, wherein the polymer material includes polydimethylsiloxanes (PDMS) including a functional group.

9. The touch panel of claim 1, wherein the particles include a conductive material.

10. The touch panel of claim 1, wherein the particles include silica.

11. The touch panel of claim 1, wherein the particles have a diameter in a range of 50 nm to 10 μm.

12. The touch panel of claim 1, wherein a volumetric ratio of the particles to the base is in a range of 5% to 30%.

13. The touch panel of claim 1, wherein the base has a refractive index corresponding to a refractive index of the particles.

14. The touch panel of claim 1, wherein the base has a refractive index equal to a refractive index of the particles.

15. The touch panel of claim 1, wherein the piezoelectric part has a thickness in a range of 100 μm to 4 mm.

16. The touch panel of claim 1, wherein the electrode comprises:
a first electrode on the first substrate, the first electrode extending in a first direction; and
a second electrode on the second substrate, the second electrode extending in a second direction crossing the first direction.

17. The touch panel of claim 1, wherein the piezoelectric part is placed between the first substrate and the second substrate.
